(19) United States
(12) Patent Application Publication
(10) Pub. No.: US 2003/0105698 A1
(43) Pub. Date: Jun. 5, 2003

(54) Employing stickiness and stock prices for employee benefits

(75) Inventors: Carl Phillip Gusler, Austin, TX (US); Rick Allen Hamilton II, Charlottesville, VA (US)

Correspondence Address: PAUL D. HEYDON, PATENT ATTORNEY, 909 NE LOOP 410, SUITE 300, SAN ANTONIO, TX, 78209, US

(73) Assignee: International Business Machines Corporation, Armonk, NY

(21) Appl. No.: 10/005,138

(22) Filed: Dec. 5, 2001

(51) Int. Cl. G06F 17/60

(52) U.S. Cl. 705/36

(57) ABSTRACT

The invention comprises defining a time interval, providing an employee benefit (e.g. a stock option, SAR, or other employee benefit related to stock prices), providing a supported price for the employee benefit, and calculating a value for the employee benefit, based on the supported price. For example, the following are provided: methods for providing an employee benefit, and providing a supported price for the employee benefit, systems for executing such methods, and instructions on a computer-usable medium, for executing such methods.

### FIELD OF THE INVENTION

The present invention relates generally to methods and systems for providing employee benefits, and more particularly to providing employee benefits that are related to stock prices.

### BACKGROUND OF THE INVENTION

Various approaches to handling stock options have been proposed in the past, including the following examples: U.S. Pat. No. 5,671,363 (Cristofich et al., Sep. 23, 1997), U.S. Pat. No. 6,173,270 B1 (Cristofich et al., Jan. 9, 2001), and U.S. Pat. No. 6,269,346 B1 (Cristofich et al., Jul. 31, 2001). However, the above-mentioned examples address substantially different problems (i.e. problems of managing stock option accounts), and thus are significantly different from the present invention. Another example is U.S. Pat. No. 6,161,096 (Bell, Dec. 12, 2000) which involves life insurance. However, none of the above-mentioned examples contain anything novel regarding stock prices.

Employee stock options have become relatively common, particularly among technology-based companies. However, after the employer's stock increases in price, and an employee exercises a stock option for a gain, the employee has a reduced incentive to stay with the employer. Employers need to attract and retain talented, productive employees for the long term. Thus there is a need for new systems and methods that link the employee's financial well-being to the employer's financial wellbeing, that motivate the employee to stay with the same employer for a long period of time, and that motivate the employee to strive to increase the employer's financial well-being throughout that period of time.

### SUMMARY OF THE INVENTION

An example of a solution to problems mentioned above comprises defining a time interval, providing an employee benefit, providing a supported price for the employee benefit, and calculating a value for the employee benefit, based on the supported price. “Supported price” means a special value pertaining to stock, used in providing employee benefits to one or more employees, analogous to a guaranteed price set by a price-support program for agricultural products, for example.

Consider some further examples. It would be advantageous to motivate a talented, productive employee to “stick with” the task of increasing the employer's financial well-being over the long term. This could be done by providing an employee benefit (stock options or stock appreciation rights for example), and providing a supported price (derived from the price of the employer's stock) for the employee benefit. It would be advantageous to reward the employee for increases in the price of the employer's stock, without the employee needing to immediately exercise a stock option for a gain when the stock price hits a high point. Thus the employee benefit would have a persistent or “sticky” quality. “Supported price” includes but is not limited to a) a peak price, or b) an average value, such as a moving average, that is higher than any other average value obtained by the same averaging method in a certain time interval, or c) some multiple of the actual price at the end of a time interval.

### BRIEF DESCRIPTION OF THE DRAWINGS

A better understanding of the present invention can be obtained when the following detailed description is considered in conjunction with the following drawings. The use of the same reference symbols in different drawings indicates similar or identical items.

FIG. 1 illustrates a simplified example of a computer system capable of performing the present invention.

FIG. 2 is a chart illustrating examples of stock prices and moving averages that may be used according to the teachings of the present invention.

FIG. 3 is a flow chart illustrating an example of a method for providing compensation.

FIG. 4 is a flow chart illustrating an example of a method for providing stock options.

FIG. 5 is a flow chart illustrating an example of a method for providing stock appreciation rights.

FIG. 6 is a diagram illustrating an example of a system for providing employee benefits.

### DETAILED DESCRIPTION

The examples that follow may involve the use of one or more computers and may involve the use of one or more communications networks. The present invention is not limited as to the type of computer on which it runs, and not limited as to the type of network used. In general, the examples that follow may be implemented with conventional systems and methods for providing employee benefits, with modifications allowing the use of supported prices. Useful background information regarding the present invention may be found in a book edited by Jerry S. Rosenbloom, The Handbook of Employee Benefits: Design, Funding and Administration, 5th ed., 2001, McGraw-Hill, N.Y.

The following are definitions of terms used in the description of the present invention and in the claims:

“Computer-usable medium” means any carrier wave, signal or transmission facility for communication with computers, and any kind of computer memory, such as floppy disks, hard disks, Random Access Memory (RAM), Read Only Memory (ROM), CD-ROM, flash ROM, non-volatile ROM, and non-volatile memory.

“Employee” includes regular full time employees, part time workers, and contract workers.

“Employee benefit” means any bonus, compensation, incentive, remuneration, or reward provided to an employee.

“Exercise” means to purchase stock according to a stock option.

“Option price,” also known as “exercise price,” “grant price,” “purchase price,” or “strike price,” means a set price for purchasing stock according to a stock option.

“Peak price” means an actual price that is higher than any other price observed in a certain time interval.

“Selected stock” means stock of any corporation, including an employer, or a parent, subsidiary, or affiliate of an employer, where such stock is related to an employee benefit.

“Stock appreciation right” or “SAR” means an account maintained for an employee that reflects the appreciation in a stock over a certain period; or an employee's opportunity to realize the appreciation in the value of a stock, without the employee actually purchasing the stock. Payment of the appreciation may be in cash, in stock, or in a combination of cash and stock.

“Stock option” means an opportunity to purchase stock at a set price for a fixed period of time.

“Storing” data or information, using a computer, means placing the data or information, for any length of time, in any kind of computer memory, such as floppy disks, hard disks, Random Access Memory (RAM), Read Only Memory (ROM), CD-ROM, flash ROM, non-volatile ROM, and non-volatile memory.

“Supported price” means a special value pertaining to stock, used in providing employee benefits to one or more employees, analogous to a guaranteed price set by a price-support program for agricultural products, for example. “Supported price” includes but is not limited to a) a peak price, or b) an average value, such as a moving average, that is higher than any other average value obtained by the same averaging method in a certain time interval, or c) some multiple of the actual price at the end of a time interval.

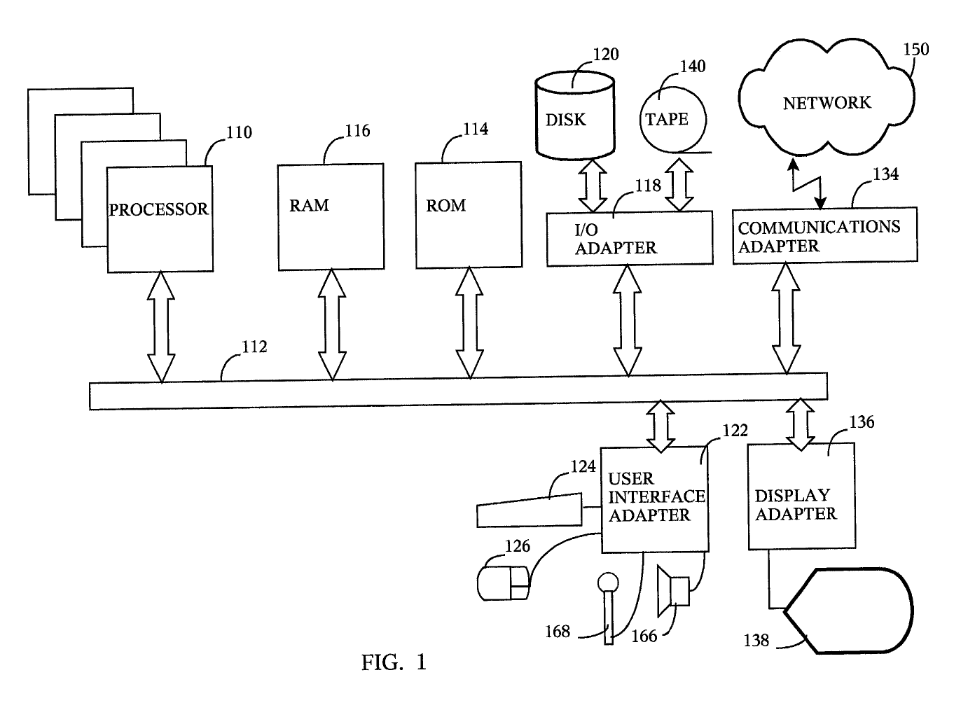

FIG. 1 illustrates a simplified example of an information handling system that may be used to practice the present invention. The invention may be implemented on a variety of hardware platforms, including personal computers, workstations, servers, mainframes, and embedded systems. The computer system of FIG. 1 has at least one processor 110. Processor 110 is interconnected via system bus 112 to random access memory (RAM) 116, read only memory (ROM) 114, and input/output (I/O) adapter 118 for connecting peripheral devices such as disk unit 120 and tape drive 140 to bus 112. The system has user interface adapter 122 for connecting keyboard 124, mouse 126, or other user interface devices such as audio output device 166 and audio input device 168 to bus 112. The system has communication adapter 134 for connecting the information handling system to a data processing network 150, and display adapter 136 for connecting bus 112 to display device 138. Communication adapter 134 may link the system depicted in FIG. 1 with hundreds or even thousands of similar systems, or other devices, such as remote printers, remote servers, or remote storage units. The system depicted in FIG. 1 may be linked to both local area networks (sometimes referred to as Intranets) and wide area networks, such as the Internet.

While the computer system described in FIG. 1 is capable of executing the processes described herein, this computer system is simply one example of a computer system. Those skilled in the art will appreciate that many other computer system designs are capable of performing the processes described herein.

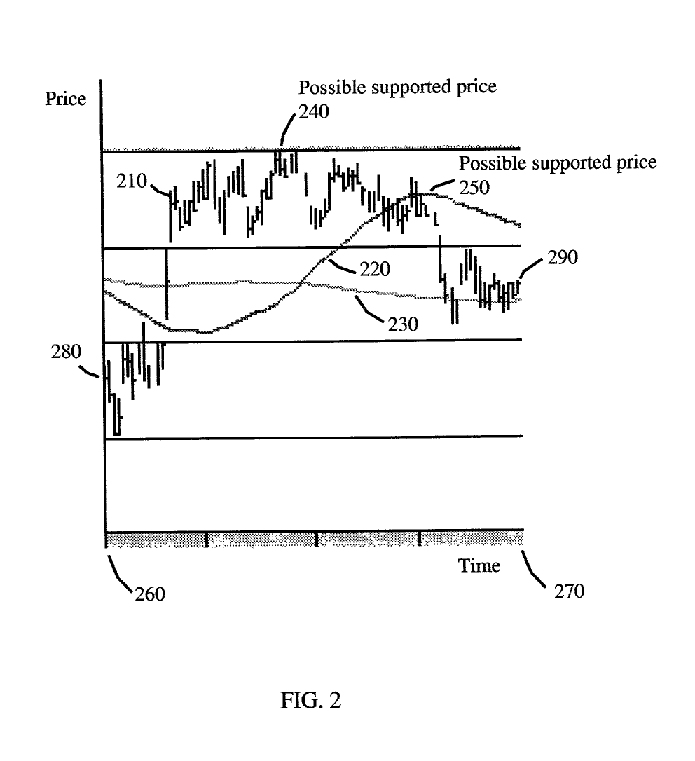

FIG. 2 is a chart illustrating examples of stock prices and moving averages that may be used according to the teachings of the present invention. Charts similar to this are used in books, magazines, newspapers and web sites, and used by software products, to display stock prices and calculations involving stock prices. A time interval is shown, having a beginning time 260 and an ending time 270. Line 210 represents actual prices of a stock at various times; these may be daily, weekly, or monthly closing prices, for example. One example of the present invention involves calculating a value for an employee benefit by calculating the difference between the price of a selected stock at the beginning of an interval (such as the price at 280), and a supported price. One possible supported price for a selected stock during an interval is a maximum or peak price (such as the price shown at 240).

Line 220 represents a moving average that smooths out price fluctuations; this may be a 10-day or 50-day moving average, for example. A moving average is a widely—used tool for analyzing stock prices. For example, a simple 10-day moving average would be calculated as follows: add the 10 most recent daily closing prices, and divide the sum by 10; repeat this operation each day, dropping the oldest daily closing price and replacing it with the newest. There are other ways of calculating a moving average, using different lengths of time, or using weighted values for example. A possible formula for a supported price might set the supported price equal to a maximum in a moving average, such as the maximum shown at 250. Line 230 represents another moving average that could be used.

Another possible formula for a supported price might set the supported price equal to a multiple of the price of a selected stock at the end of an interval (e.g. a multiple of the price at 290). Possible supported prices include 1.5 times the price of a selected stock at the end of an interval, or twice the price of a selected stock at the end of an interval, for example. A formula for a supported price might utilize more than one measurement of stock price. For example, a formula for a supported price might fix the supported price at the lesser of: (a) a peak price (such as the peak price shown at 240) or (b) twice the price of a selected stock at the end of an interval (such as twice the price shown at 290). As another example, a formula for a supported price might fix the supported price at the lesser of: (a) a maximum in a moving average (such as the maximum shown at 250), or (b) 1.5 times the price of a selected stock at the end of an interval (such as 1.5 times the price shown at 290).

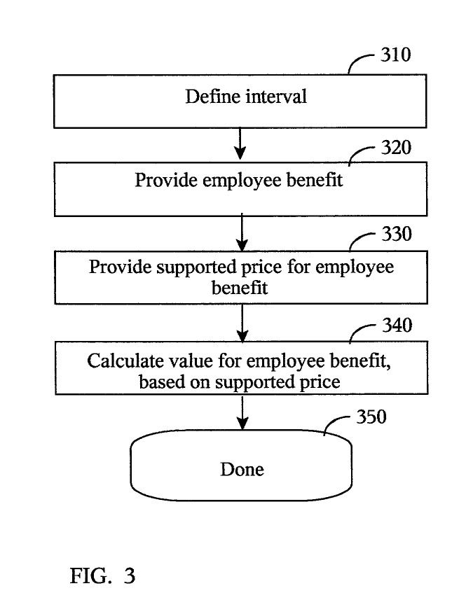

FIG. 3 is a flow chart illustrating an example of a method for providing compensation. This example involves defining a time interval, at block 310. The interval could have any length that the employer deems effective, or any length that the employer and employee agree upon. Next is providing an employee benefit, at block 320. This may involve providing one or more stock options, stock appreciation rights (SAR's) or some other employee benefit related to stock prices. Next is providing a supported price for the employee benefit, at block 330. This may be done by agreement between employer and employee. Offering to buy shares of stock from an employee at a supported price, or agreeing to give SAR's a value based on a supported price, are two examples. Supported prices are discussed above. Next, at block 340, is calculating a value for the employee benefit, based on the supported price. For example, this may involve calculating the difference between the price of a selected stock at the beginning of said interval, and said supported price. As another example, this may involve calculating the difference between a discounted option price, and said supported price. Block 350 represents the completion of the process.

The following are some examples of calculating a value for the employee benefit (block 340): calculating a gain from the exercise of a stock option, carrying out a cashless exercise of a stock option (where an employee is not required to pay cash for shares), calculating the value of a SAR, making payment to an employee under a SAR, and calculating tax consequences or tax withholding connected with an employee benefit. Calculations may be computerized, or may involve inspecting price data in tables or graphs, or may be done with paper and pencil, or may involve a combination of methods.

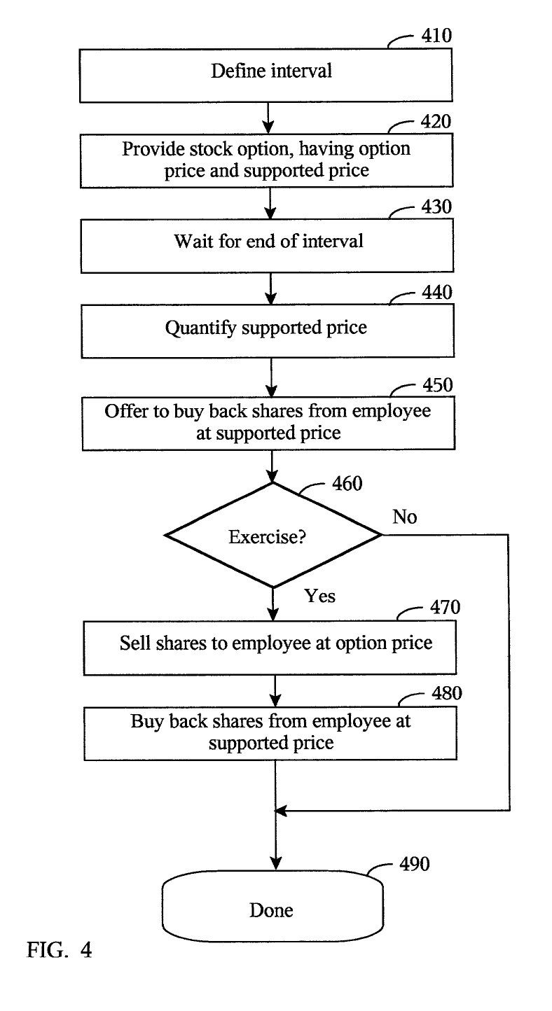

FIG. 4 is a flow chart illustrating an example of a method for providing stock options. This example begins with defining a time interval, at block 410. The interval could have any length that the employer deems effective, or any length that the employer and employee agree upon. Next is providing a stock option, having an option price and a supported price associated with it, at block 420. Next, this example involves waiting for the end of the interval, at block 430. In this example, said stock option may be exercised after the end of said time interval. As an alternative example, said stock option may be exercised before the end of said time interval. Next, this example involves quantifying the supported price, at block 440 (e.g. using stock price data, and a formula for a supported price), and then offering to buy shares of stock from an employee at a supported price, at block 450. The party offering to buy back shares may be the employer, or an agent of the employer. If the employee decides not to exercise the stock option, the “No” branch is taken at decision 460, and this example is finished. If on the other hand the employee decides to exercise the stock option, the “Yes” branch is taken at decision 460. Next the employer, or an agent of the employer, sells shares to the employee at the option price, at block 470. Next the employer, or an agent of the employer, buys shares of stock from the employee at the supported price, at block 480. Block 490 represents the completion of the process. The process may involve automated or manual methods, as described above regarding FIG. 3, block 340.

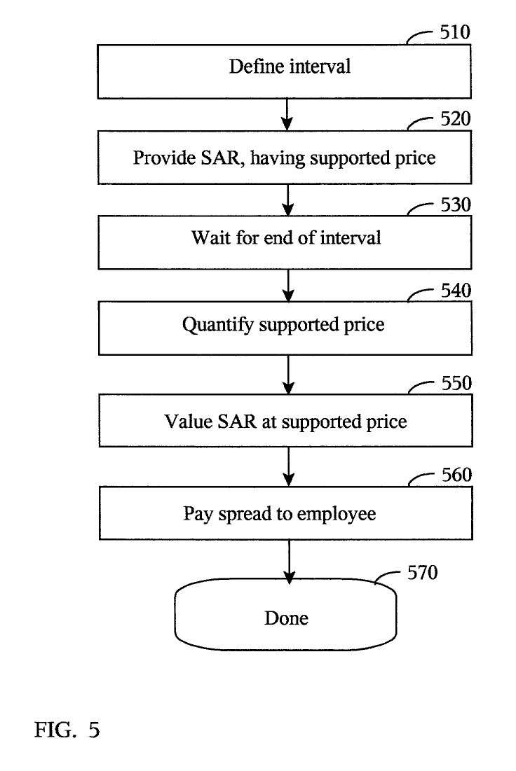

FIG. 5 is a flow chart illustrating an example of a method for providing stock appreciation rights. This example begins with defining a time interval, at block 510. The interval could have any length that the employer deems effective, or any length that the employer and employee agree upon. Next is providing stock appreciation rights, having a supported price, at block 520. Next, this example involves waiting for the end of the interval, at block 530, and then quantifying the supported price, at block 540 (e.g. using stock price data, and a formula for a supported price). At block 550, the value of the SAR is determined, using the supported price. For example, this may involve calculating the difference between the price of a selected stock at the beginning of said interval, and said supported price. At block 560, the amount of the appreciation (or “spread”) is paid to the employee. Block 570 represents the completion of the process. The process may involve automated or manual methods, as described above regarding FIG. 3, block 340.

Those skilled in the art will recognize that blocks in the above-mentioned flow charts could be arranged in a somewhat different order, but still describe the invention. Blocks could be added to the above-mentioned flow charts to describe details, or optional features; some blocks could be subtracted to show a simplified example.

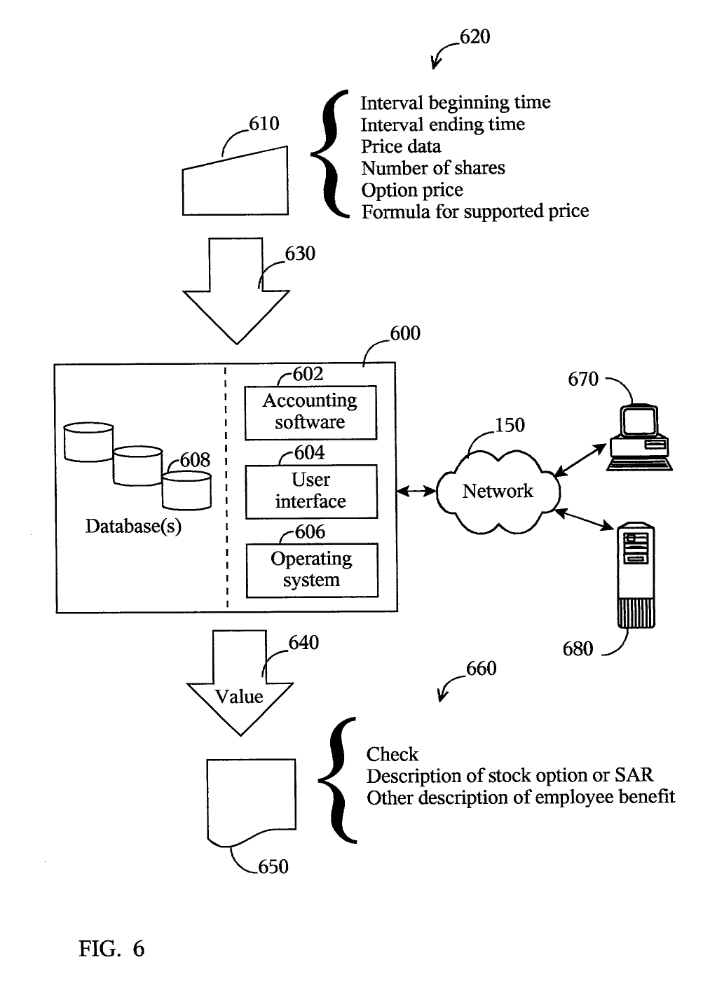

FIG. 6 is a diagram illustrating an example of a system for providing employee benefits. System 600, shown at the center of FIG. 6, may be implemented using components such as those shown in FIG. 1 and described above. While the computer system described in FIG. 1 is capable of executing the processes described herein, this computer system is simply one example of a computer system. Those skilled in the art will appreciate that many other computer system designs are capable of performing the processes described herein. System 600 includes hardware and software means for receiving inputs. Inputs are indicated by input symbol 610, and input data flow is indicated by arrow 630. Inputs may include stock price data, and a formula for a supported price, for example. Some examples of typical inputs are listed at 620: interval beginning time, interval ending time, price data, number of shares, option price, and a formula for a supported price.

System 600 includes hardware and software means for calculating a value for an employee benefit, based on said inputs. Accounting software 602, user interface 604, and operating system 606 are some examples of software that may be included in System 600. Any kind of mutually compatible accounting software, user interface and operating system may be used. Accounting software 602 represents conventional accounting software that performs some or all of the following functions: maintaining accounts (including accounts related to stock), preparation and printing of reports and checks, and causing a transfer of funds. A web server (not shown) is an optional component that may be incorporated into system 600, as a way of making output 640 accessible via network 150. As indicated by the dashed line, one or more databases (shown at 608) may be incorporated into system 600, or may be independent of, but accessible to, system 600. One or more databases 608 may contain the kind of data listed at 620, employee data, data concerning employee benefits, and other useful data, for example.

System 600 includes hardware and software means for providing at least one output, including said value for an employee benefit (indicated by arrow 640). System 600 may also include means for creating a document containing a description of an employee benefit, based on output 640. Some examples of typical documents are listed at 660: a check, a description of a stock option or SAR, and other descriptions of employee benefits (such as an email message or a web page for example).

This example shows system 600 communicating, via network 150, with other systems, symbolized by computer 670 and computer 680. This communication via network 150 provides one way for causing a transfer of funds, based on output 640. For example, system 600 may send a signal to a bank's server (such as computer 680), causing a transfer of funds, in connection with an SAR, or in connection with buying shares of selected stock from an employee at a supported price. This communication via network 150 also provides some possible ways to handle input 610, output 640, and document 650.

In conclusion, examples have been shown of methods and systems for providing an employee benefit, and providing a supported price for the employee benefit.

One of the possible implementations of the invention is an application, namely a set of instructions (program code) in a code module which may, for example, be resident in the random access memory of a computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer-usable medium having computer-executable instructions for use in a computer. In addition, although the various methods described are conveniently implemented in a general-purpose computer selectively activated or reconfigured by software, one of ordinary skill in the art would also recognize that such methods may be carried out in hardware, in firmware, or in more specialized apparatus constructed to perform the required method steps.

While the invention has been shown and described with reference to particular embodiments thereof, it will be understood by those skilled in the art that the foregoing and other changes in form and detail may be made therein without departing from the spirit and scope of the invention. The appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the appended claims may contain the introductory phrases “at least one” or “one or more” to introduce claim elements. However, the use of such phrases should not be construed to imply that the introduction of a claim element by indefinite articles such as “a” or “an” limits any particular claim containing such introduced claim element to inventions containing only one such element, even when the same claim includes the introductory phrases “at least one” or “one or more” and indefinite articles such as “a” or “an;” the same holds true for the use in the claims of definite articles.

We claim:

1. A method for providing compensation, said method comprising:
defining a time interval;
providing a stock option to an employee for a selected stock;
identifying a supported price for said selected stock, based on price data for said interval; and
offering to buy shares of said selected stock from said employee at said supported price.

2. The method of claim 1, wherein:
said stock option may be exercised after the end of said time interval.

3. The method of claim 1, wherein:
said stock option may be exercised before the end of said time interval.

4. A method for providing compensation, said method comprising:
defining a time interval;
providing an employee benefit;
providing a supported price for said employee benefit, based on price data for said interval; and
calculating a value for said employee benefit, based on said supported price.

5. The method of claim 4, wherein:
said providing an employee benefit further comprises providing a stock option; and
said providing a supported price further comprises offering to buy shares of stock from said employee.

6. The method of claim 4, wherein:
said providing an employee benefit further comprises providing a stock appreciation right.

7. The method of claim 4, wherein said calculating further comprises calculating the difference between the price of a selected stock at the beginning of said interval, and said supported price.

8. The method of claim 4, wherein:
said supported price is a peak price attained by a selected stock during said interval.

9. The method of claim 4, wherein:
said supported price is a maximum value produced by an averaging method.

10. The method of claim 4, wherein:
said supported price is a multiple of the price of a selected stock at the end of said interval.

11. A system for providing compensation, said system comprising:
means for receiving inputs, including:
stock price data, and
a formula for a supported price;
means for calculating a value for an employee benefit, based on said inputs; and
means for providing at least one output, including said value.

12. The system of claim 11, wherein said inputs include one or more inputs selected from the group consisting of:
a beginning time,
an ending time,
a number of shares,
and an option price.

13. The system of claim 11, wherein said means for calculating further comprises means for calculating a value for a stock option.

14. The system of claim 11, wherein said means for calculating further comprises means for calculating a value for a stock appreciation right.

15. The system of claim 11, further comprising means for creating a document containing a description of said employee benefit, based on said output.

16. The system of claim 11, further comprising means for printing a check, based on said output.

17. The system of claim 11, further comprising means for causing a transfer of funds, based on said output.

18. The system of claim 11, wherein said means for calculating further comprises means for calculating the difference between the price of a selected stock at the beginning of said interval, and said supported price.

19. The system of claim 11, wherein:
said supported price is a peak price attained by said selected stock during said interval.

20. The system of claim 11, wherein:
said supported price is a maximum value produced by an averaging method.

21. The system of claim 11, wherein:
said supported price is a multiple of the price of said selected stock at the end of said interval.

22. A computer-usable medium having computer-executable instructions for providing compensation, said computer-executable instructions comprising:
means for receiving inputs, including:
stock price data, and
a formula for a supported price;
means for calculating a value for an employee benefit, based on said inputs; and
means for providing at least one output, including said value.

23. The computer-usable medium of claim 22, wherein said inputs include one or more inputs selected from the group consisting of:
a beginning time,
an ending time,
a number of shares,
and an option price.

24. The computer-usable medium of claim 22, wherein said means for calculating further comprises means for calculating a value for a stock option.

25. The computer-usable medium of claim 22, wherein said means for calculating further comprises means for calculating a value for a stock appreciation right.

26. The computer-usable medium of claim 22, further comprising means for creating a document containing a description of said employee benefit, based on said output.

27. The computer-usable medium of claim 22, further comprising means for printing a check, based on said output.

28. The computer-usable medium of claim 22, further comprising means for causing a transfer of funds, based on said output.

29. The computer-usable medium of claim 22, wherein said means for calculating further comprises means for calculating the difference between the price of a selected stock at the beginning of said interval, and said supported price.

30. The computer-usable medium of claim 22, wherein: said supported price is a peak price attained by said selected stock during said interval.

31. The computer-usable medium of claim 22, wherein: said supported price is a maximum value produced by an averaging method.

32. The computer-usable medium of claim 22, wherein: said supported price is a multiple of the price of said selected stock at the end of said interval.
